(19) United States
(12) Patent Application Publication
(10) Pub. No.: US 2010/0203351 A1
(43) Pub. Date: Aug. 12, 2010

(54) HIGH STRENGTH COMPOSITE MATERIALS AND RELATED PROCESSES

(76) Inventor: Taysir H. Nayfeh, Cleveland, OH (US)

Correspondence Address: FAY SHARPE LLP, 1228 Euclid Avenue, 5th Floor, The Halle Building, Cleveland, OH, 44115, US

(21) Appl. No.: 12/303,612

(22) PCT Filed: Jun. 7, 2007
(86) PCT No.: PCT/US07/13406

§ 371 Date: Mar. 26, 2010

Related U.S. Application Data
(60) Provisional application No. 60/812,389, filed on Jun. 9, 2006.

(51) Int. Cl. B32B 15/14; B32B 17/12; D02G 3/00; C03C 14/00; C03B 37/012

(52) U.S. Cl. 428/622; 428/292.1; 428/293.1; 428/293.7; 428/372; 65/442; 977/750; 977/752; 977/762

(57) ABSTRACT

Composite materials exhibiting very high strength properties and other characteristics are disclosed. The materials comprise one or more nanomaterials dispersed within one or more matrix materials. The nanomaterials can be in a variety of forms, such as for example, carbon nanotubes and/or nanofibers. The matrix material can be glass, fused silicas, or metal. Also disclosed are various processes and operations to readily disperse and uniformly align the nanotubes and/or nanofibers in the flowing matrix material, during production of the composite materials.

### CROSS-REFERENCES TO RELATED APPLICATION

The present application claims priority upon U.S. provisional application Ser. No. 60/812,389 filed Jun. 9, 2006, which is also hereby incorporated by reference.

### BACKGROUND

The present invention relates to composite materials using nanomaterials or nanostructures that exhibit high strength properties and other beneficial characteristics. The invention also relates to various processes for producing such composite materials. The invention finds particular application in conjunction with composite materials utilizing certain nanostructures such as nanotubes and nanofibers, and will be described with particular reference thereto. However, it is to be appreciated that the present invention is also amenable to other like applications. For example, the invention also relates to composite materials and processes that employ other nanostructures besides, or in addition to, nanotubes and nanofibers.

The discovery of nanomaterials and particularly, those formed from carbon, has been of great interest to many researchers. This interest has led to various processes and applications being developed to exploit the unique properties of these materials. Of the many potential areas of application, the area of perhaps the greatest interest is the development of engineered composite materials using nanotubes or other nanostructures and devices. Examples of contemplated products using these materials include for example, space elevators, wires and devices that are super conductive at room temperature, and near indestructible armor.

Unfortunately, composite materials and specifically, methods utilizing nanotubes or other nanostructures to improve the properties of materials by forming nano-composite matrices, particularly those based upon glass, ceramic, or metal; have met various challenges and shortcomings. These shortcomings include poor dispersion of the nanotubes in the matrix material, primarily due to Van der Waals' forces; poor alignment and orientation of the nanotubes in the matrix; short lengths of the nanotubes relative to defect sizes in the composite matrices; and difficulties associated with handling randomly oriented nanotubes in an industrial scale process.

Well prior to the current interest in nanomaterials and their application, artisans devised various strategies for improving the physical properties of materials by forming composite materials. One such approach to increasing the strength of a glass or ceramic is to incorporate relatively large fibers or fiber bundles into the glass or ceramic material. Typically, such fibers are comprised of carbon or silicon carbide. This technology was described for example, in 1985 in German Patent DE 3516920 to Roeder et al. However, this technology is directed to macro-sized materials and their applications in contrast to nanomaterials. Accordingly, there exists a need for a process utilizing nanomaterials in such a manner so as to attain a composite material that exhibits the remarkable properties of the incorporated nanomaterials.

Research has previously been conducted concerning composite materials using carbon nanotubes. Specifically, in “Extraordinary Strengthening Effect of Carbon Nanotubes in Metal-Matrix Nanocomposites Processed by Molecular-Level Mixing,” Adv, Mater. 2005, 17, 1377-1381, Cha et al. describe a process for fabricating composite powders of carbon nanotubes homogeneously implanted within copper powders. The process is described as “molecular-level mixing.” The resulting composite is said to exhibit extremely high strength. Although offering advantages over previously known composite materials, this process uses multiple processing operations such as suspending the carbon nanotubes in a solvent by surface functionalization, mixing copper ions with the carbon nanotube suspension, followed by drying, calcinations, and reduction operations. Therefore, it is believed that this strategy would be costly to implement on a large scale industrial level. In addition, this strategy is likely limited to metal matrix materials and could not be used for glass or ceramic matrix materials. Furthermore, due to the methods adopted by Cha et al., this work does not address problems of poor dispersion of nanotubes in the matrix material, poor alignment and orientation of the nanotubes in the matrix, short lengths of the nanotubes relative to defect sizes in the composite material, and difficulties associated with handling the nanotubes in a large scale process.

Artisans have also investigated methods for assembling nanostructures into components or larger structures that can be more readily utilized on a macro scale, such as in an industrial process. Zhang et al. in “Multifunctional Carbon Nanotube Yarns by Downsizing an Ancient Technology,” Vol. 306, Science (Nov. 19, 2004), describe introducing twist during spinning of multi-walled carbon nanotubes. The resulting multi-ply, torque-stabilized yarns are noted as exhibiting high tensile strengths, flexibility, and excellent toughness. Although providing a high strength yarn product, this technology would again, be difficult to implement at an industrial level, costly to undertake, and essentially be limited to forming yarns or collections of single material fibers. Furthermore, this technology does not relate to composite materials using glass, ceramic, or metal matrices. And so, this work is silent with regard to overcoming the difficulties associated with attempting to align and specifically orient nanostructures within a material matrix. The work is also silent with regard to reducing defects within a composite material. Nor does this work provide a practical strategy for handling the exceedingly small nanotubes.

Greywall, in U.S. Patent Publication No. 2005/0188727, described a method for assembling small carbon particles such as carbon fibrils and carbon nanotubes into aligned fibers by dispersing the particles into a flowable medium such as glass, drawing the glass to at least partially align the particles with respect to each other, and then removing the glass material to leave an assembled collection of carbon particles, fibrils, and/or nanotubes in the form of a fiber or strand. Greywall relies upon well known techniques for manufacturing optical fibers, and chemical or mechanical methods to remove the glass vehicle to form the fibers exclusively comprising the carbon structures. Greywall's technique produces single fibers of carbon particles, fibrils, and/or nanotubes. Greywall did not address difficulties associated with dispersing the carbon particles in the medium since Greywall relies upon a drawing operation to align and assemble the particles before removing the medium. Although satisfactory in certain regards, the use of a drawing operation to align particles is not always possible with all materials or in all applications. Furthermore, Greywall's work is directed to forming fibers of a single material and is not concerned with strategies for incorporating nanomaterials into other materials to form composite materials which obtain the benefits of the remarkable properties of the incorporated nanomaterials. In addition, Greywall's work is silent with regard to reducing defects in the final material. Accordingly, a need remains for an improved method of incorporating nanomaterials in a glass, ceramic, or metal matrix, that overcomes the problems of the prior art to form a composite material that more fully exhibits the physical properties associated with the incorporated nanomaterials.

Many methodologies have been proposed and are currently being explored to improve the dispersing of nanotubes and/or nanofibers in a material matrix. However, such methods have only produced marginal improvements and in some cases, have only resulted in a weaker matrix by introducing additional inclusions and porosity into the resulting material. Accordingly, a need exists for an improved method for producing a composite material utilizing nanostructures such as nanotubes and/or nanofibers. Specifically, it would be beneficial to provide a method for improving the dispersal of nanotubes and/or nanofibers in a material matrix. It would also be beneficial to provide a technique for aligning and orientating nanostructures within a matrix material.

In summary, currently known methods of incorporating randomly oriented nanotubes and/or lower performance and much lower cost nanofibers in composite materials, result in isotropic matrices with only moderate improvements in the properties and performance of the resulting materials. The resulting materials fail to exhibit the projected quantum improvements based on the superior directional properties of the nanotubes and the nanofibers. Therefore, it would be beneficial to provide composite materials utilizing nanotubes and/or nanofibers, and related methods of forming which exhibit superior properties and which are not prone to the problems associated with currently known materials and processes, e.g. high defects and insufficiently dispersed or misaligned nanostructures.

### BRIEF DESCRIPTION

In a first aspect, the present invention provides a process for producing a high strength composite material comprising an effective amount of at least one type of nanostructure having an aspect ratio greater than 1.0, and a matrix material. The process comprises providing a matrix material. The process also comprises heating the matrix material such that the matrix material is flowable. The process further comprises providing at least one type of nanostructure having an aspect ratio greater than 1.0. The process also comprises combining an effective amount of the at least one type of nanostructure with the matrix material. The process further comprises flowing in a laminar fashion, the combined amount of nanostructures with the matrix material, to thereby cause at least a majority of the nanostructures to adopt a parallel orientation in the matrix material. The process also comprises solidifying the composite material while the nanostructures are in the parallel orientation in the matrix material to thereby produce the high strength composite material.

In yet another aspect, the present invention provides a process for dispersing and aligning nanostructures in a matrix material. The process comprises selecting nanostructures having an aspect ratio greater than 1.0. The process also comprises providing a flowable matrix material. The process further comprises combining the selected nanostructures in the flowable matrix material. And, the process comprises flowing, in a laminar fashion, the combined matrix material and selected nanostructures for a period of time sufficient to cause at least a majority of the nanostructures to adopt a parallel orientation in the matrix material.

In yet another aspect of the present invention, a high strength composite material is provided. The material comprises a matrix material and an effective amount of at least one type of nanostructure having an aspect ratio greater than 1.0. At least a majority of the nanostructures having an aspect ratio greater than 1.0 are aligned in a parallel orientation with respect to each other.

In still another aspect, the present invention provides a composite material comprising a reinforcing composite material that includes (i) a first matrix material and (ii) an effective amount of at least one type of nanostructure having an aspect ratio greater than 1.0 dispersed in the first matrix material. The composite material also comprises a secondary matrix material. At least a majority of the nanostructures in the first matrix material are aligned in a parallel orientation.

### BRIEF DESCRIPTION OF THE DRAWINGS

FIG. 1 is a force diagram illustrating a turning moment exerted upon a nanotube or nanofiber in a flow stream.

FIG. 2 is a velocity profile of a material flowing in a laminar fashion.

FIG. 3 is a force diagram illustrating attainment of a zero turning moment.

FIG. 4 is a schematic illustration of shear dispersing of carbon nanofibers and inclusions in a preferred embodiment composite material according to the present invention.

FIG. 5 is a detailed infrared image of glass fiber bushing tips used in an optional operation of a preferred embodiment process of the present invention.

FIG. 6 is a photograph of preferred embodiment filaments comprising carbon nanofibers fluorescing under UV long wavelength (354 nm) light.

FIG. 7 is a micrograph of multi-wall carbon nanofibers/nanotubes used in the preferred embodiment materials and processes.

FIG. 8 is a micrograph of well dispersed carbon nanotubes in a preferred embodiment composite fiber.

FIG. 9 is a graph of tensile strength tests of virgin and preferred embodiment fibers.

FIG. 10 are micrographs of fracture surfaces of E glass filaments with and without carbon nanofibers.

FIG. 11 are micrographs of well dispersed and aligned carbon nanotubes in the preferred embodiment glass fibers.

FIG. 12 is a graph of fracture toughness of glass and boron nitride reinforced glass.

FIG. 13 is a graph of Weibull strength distribution of the glass and boron nitride nanotube reinforced glass referenced in FIG. 12.

FIG. 14 is a schematic illustration of a preferred embodiment process for glass fiber drawing and production.

FIG. 15 is a schematic cross-sectional view of a preferred embodiment composite material in accordance with the present invention.

FIG. 16 is a schematic cross-sectional view of another preferred embodiment composite material in accordance with the present invention.

FIGS. 17 and 17A are schematic views of another preferred embodiment composite material in accordance with the present invention.

FIG. 18 is a schematic view of another preferred embodiment composite material in accordance with the present invention.

FIG. 19 is a schematic view of an assembly used in a roller and wire drawing process, which can be used in association with the present invention.

FIG. 20 is a schematic view of laminar flow of a material, which can be utilized in association with the present invention.

FIG. 21 is a schematic view of an extrusion assembly which can be used in association with the present invention.

### DETAILED DESCRIPTION

The present invention and preferred embodiments relate to incorporating or imbedding, dispersing and orienting nanostructures such as nanofibers and/or nanotubes (NF/NT) in glass, fused silica(s), and metal matrices and other materials to produce exceptionally strong nano-composite glass fibers, metal wires, sheets, plates, and structures with highly enhanced physical, thermal and electrical properties. In certain embodiments of the invention, the nanofibers and/or nanotubes are highly aligned or otherwise uniformly oriented in the material matrix.

The present invention provides in a broad aspect, a unique and ready strategy to disperse, disentangle or separate if necessary, and/or selectively align a collection of nanostructures in a matrix material. The strategy transforms the combined matrix material and nanomaterials into a flowable state, and then induces the combination to then flow. Flow can occur within nearly any type of channel, duct, or enclosure. It is contemplated that in certain applications such flow could occur on only a single surface such as a substrate. As explained in greater detail herein, it is preferred that the flow of the combined mass be in the laminar regime. Alternately or in addition, it is preferred that the velocity profile of the flow exhibit a parabolic shape, or substantially so. This type of flow produces velocity differentials which in turn, are utilized to impart turning or rotational moments upon the nanostructures.

Before describing the present invention and various preferred embodiments thereof, it is instructive to consider nanotechnology in general and various terminology as used herein.

Materials reduced to the nanoscale can suddenly show very different properties compared to what they exhibit on a macroscale, enabling unique applications. For instance, opaque substances can become transparent (copper); inert materials can become catalysts (platinum); stable materials can turn combustible (aluminum); solids can turn into liquids at room temperature (gold); and insulators can become conductors (silicon). Specifically, materials such as gold, when chemically inert at normal scales, can serve as a potent chemical catalyst at nanoscales. Much of the fascination with nanotechnology stems from these unique quantum and surface phenomena that matter exhibits at the nanoscale.

A nanostructure as that term is used herein, is a structure having an intermediate size between molecular and microscopic (micrometer sized) structures. In describing nanostructures, it is convenient to differentiate between the number of dimensions on the nanoscale. One dimensional nanostructures such as nanotextured surfaces have one dimension on the nanoscale, i.e., only the thickness of the surface of such an object is between 0.1 and 100 nm. Two dimensional nanostructures such as relatively long nanotubes have two dimensions on the nanoscale, i.e., the diameter of the tube is between 0.1 and 100 nm, however its length is much greater, and so beyond the nanoscale. Finally, three dimensional nanostructures such as spherical nanoparticles have three dimensions on the nanoscale, i.e., the particle is between 0.1 and 100 nm in each spatial dimension. Another example of a three dimensional nanostructure is a relatively short nanotube, i.e. the diameter and length of the tube being between 0.1 and 100 nm. The present invention encompasses the use of all of these types of nanostructures.

Specifically, a nanotube is a nanometer scale wire-like structure that is most often composed of carbon. Generally, these structures have an open or hollow interior.

Carbon nanotubes (CNTs) are allotropes of carbon. A single wall carbon nanotube is a one-atom thick sheet of graphite (called grapheme) rolled up into a seamless cylinder with a diameter of the order of a nanometer. This results in a nanostructure where the length-to-diameter ratio typically exceeds 10,000. Such cylindrical carbon molecules have novel properties that make them potentially useful in a wide variety of applications in nanotechnology, electronics, optics and other fields of materials science. They exhibit extraordinary strength and unique electrical properties, and are efficient conductors of heat. Inorganic nanotubes have also been synthesized.

Carbon nanotubes are members of the fullerene structural family, which also includes buckyballs. Whereas buckyballs are spherical in shape, a nanotube is cylindrical, with at least one end typically capped with a hemisphere of the buckyball structure. Their name is derived from their size, since the diameter of a nanotube is on the order of a few nanometers, while they can be up to several millimeters in length. There are two main types of nanotubes: single-walled nanotubes (SWNTs) and multi-walled nanotubes (MWNTs).

The nature of the bonding of a nanotube is described by applied quantum chemistry, specifically, orbital hybridization. The chemical bonding of nanotubes are composed entirely of sp² bonds, similar to those of graphite. This bonding structure, which is stronger than the sp³ bonds found in diamond, provides the molecules with their unique strength. Nanotubes naturally align themselves into “ropes” held together by Van der Walls forces. Under high pressure, nanotubes can merge together, trading some sp² bonds for sp³ bonds, giving great possibility for producing strong, unlimited-length wires through high-pressure nanotube linking.

Nanofibers as that term is used herein, are extremely long aligned nanotube arrays. Most single-walled nanotubes (SWNT) have a diameter of close to 1 nanometer, with a tube length that can be many thousands of times longer. Single-walled nanotubes with lengths up to orders of centimeters have been produced. The structure of a SWNT can be conceptualized by wrapping a one-atom-thick layer of graphite, i.e. grapheme, into a seamless cylinder.

Single-walled nanotubes are a very important variety of carbon nanotubes because they exhibit important electrical properties that are not shared by the multi-walled carbon nanotube (MWNT) variants. Single-walled nanotubes are the most likely candidate for miniaturizing electronics past the micro electromechanical scale that is currently the basis of modern electronics. The most basic building block of these systems is the electric wire, and SWNTs can be excellent conductors.

Multi-walled nanotubes (MWNT) consist of multiple layers of graphite rolled in on themselves to form a tube shape. There are two models which can be used to describe the structures of multi-walled nanotubes. In the Russian Doll model, sheets of graphite are arranged in concentric cylinders. In the Parchment model, a single sheet of graphite is rolled in around itself, resembling a scroll of parchment or a rolled up newspaper. The interlayer distance in multi-walled nanotubes is close to the distance between grapheme layers in graphite, approximately 3.3 Å. The special properties of double-walled carbon nanotubes (DWNT) must be emphasized because they combine very similar morphology and properties as compared to SWNT, while improving significantly their resistance to chemicals. This is especially important when functionalization is required (hence grafting of chemical functions at the surface of the nanotubes) to add new properties to the carbon nanotube. In the case of SWNT's, covalent functionalization will break some C=C double bonds, leaving “holes” in the structure on the nanotube and thus modifying both its mechanical and electrical properties. In the case of DWNTs, only the outer wall is modified.

As with any material, the existence of defects affects the material properties. Defects in nanotubes can occur in the form of atomic vacancies. High levels of such defects can lower the tensile strength by up to 85%. Another well-known form of defect that occurs in carbon nanotubes is known as the Stone Wales defect, which creates a pentagon and heptagon pair by rearrangement of the bonds. Because of the very small structure of carbon nanotubes, the tensile strength of the tube is dependent on the weakest segment of the nanotube in a similar manner to a chain, where a defect in a single link diminishes the strength of the entire chain.

The nanotube's electrical properties are also affected by the presence of defects. A common result is the lowered conductivity through the defective region of the tube. Some defect formation in armchair-type tubes (which can conduct electricity) can cause the region surrounding that defect to become semiconducting. Furthermore, single monoatomic vacancies induce magnetic properties.

The present invention relates to composite materials comprising (i) one or more nanostructures such as nanotubes and nanofibers and (ii) one or more matrix materials. The materials of the nanostructures are preferably carbon or carbon-based, but can also include or use instead, other materials such as boron nitride and silicon carbide for example. The selected nanostructures used in the preferred embodiment composite materials described herein can be in the form of nearly any nanostructure such as for example, nanotubes (including twisted nanotubes and armchair or “no twist” nanotubes), nanofibers, nanotube rings, nanoparticles and combinations thereof. The preferred nanostructures used in the various preferred embodiments, preferably have an aspect ratio greater than 1.0. The term “aspect ratio” as used herein, refers to the ratio of a nanostructure's longest dimension to the nanostructure's shortest dimension. As will be understood, the aspect ratio of a spherical object such as a nanoparticle or buckyball is 1.0. In contrast, the aspect ratio of a cylindrical, or wire, or strand-like object such as a nanotube or nanofiber is the ratio of the length of the nanostructure divided by the span, width, or diameter of the nanostructure. The aspect ratio of nanotubes is greater than 1.0 and may be as high as 10,000 or more. As previously noted, certain single-walled nanotubes with lengths on the order of centimeters are known. The aspect ratio of these nanotubes would likely be about 1,000,000. Preferred nanostructures are carbon nanotubes and carbon nanofibers, used either singularly or in combination with each other. It is also contemplated that nanostructures in the form of thin layers or sheets could be used. For example, certain silica materials can be formed into nanosheets. Such nanosheet materials could be used in accordance with the present invention, and thus dispersed and aligned within a flowing matrix material. The aspect ratio of nanosheets is the ratio of the sheet's length or width (and generally, the longest of these two dimensions) to the thickness of the sheet.

A wide array of nanostructures are commercially available. For instance, Applied Sciences, Inc., of Cedarville, Ohio, provides various carbon nanotubes and nanofibers through its subsidiary Pyrograf® Products, Inc. Other commercial sources of suitable nanostructures include, but are not limited to Swan Chemical, Inc., of Lyndhurst, N.J.; Nanolab of Newton, Mass.; and Ahwahnee Technology of San Jose, Calif.

The nanostructures used in the preferred embodiment processes and resulting composite materials described herein, can be formed from a wide array of elements or compounds. It will be appreciated that although carbon is a preferred candidate, other elements or compounds can be used. Non-limiting examples include boron nitride, silicon carbide, and combinations thereof.

The matrix materials used in the preferred embodiment composite materials can be selected from a wide array of materials such as glass, fused silicas, metals, and combinations and alloys thereof. Glass and metals are preferred for use as the matrix materials. Nearly any type of glass can be used. The most common glasses are oxide based, such as silicates (SiO₂), borates (B₂O₃), germinates (GeO₂) or mixtures thereof. Fused silica may be considered as a glass by artisans. Fused silica is pure or nearly pure SiO₂. Due to its structure, glass materials typically do not exhibit specific melting points, but transition from solid to molten over a temperature range. However, in the description of the embodiments of the invention using glass as a matrix material, the term melting point is generally used to refer to the lowest temperature at which the glass material can be made to undergo sufficient flow so as to orient the nanostructures dispersed therein. A particularly preferred glass is “E glass.” E glass is a low alkali borosilicate glass with good electrical and mechanical properties and good chemical resistance. The designation E is for electrical. E glass is commercially available from a number of suppliers. A wide array of metals and/or metal alloys can be used as a matrix material such as aluminum, aluminum alloys; antimony and alloys thereof; chromium and alloys thereof; cobalt and alloys thereof; copper and alloys thereof such as brass including red brass and yellow brass, beryllium copper and cupronickel; gold and alloys thereof; iron and alloys thereof such as steel, stainless steel, and Monel®; lead and alloys thereof; magnesium and alloys thereof; manganese and alloys thereof such as manganese bronze; molybdenum and alloys thereof; nickel and alloys thereof such as Hastelloy® and Inconel®; palladium and alloys thereof; platinum and alloys thereof; silver and alloys thereof; tantalum and alloys thereof; tin and alloys thereof; titanium and alloys thereof; tungsten and alloys thereof; vanadium and alloys thereof; zinc and alloys thereof; and zirconium and alloys thereof. Preferred metals include, but are not limited to copper, aluminum, and titanium.

Generally, any matrix material that can be transformed into a flowable or liquid state at a temperature below the melting point of the nanomaterials, and which is compatible with the nanomaterials, can be used. Since most carbon materials have melting points on the order of about 3500° C., nearly any matrix metal having a melting temperature below that value, would be suitable candidates. Thus, nearly all metals or alloys can be used as matrix materials since their melting points are less than 3500° C.

The preferred embodiment composite materials can also include additional ingredients and components such as, but not limited to, fillers, diluents, extenders, property modifiers, viscosity adjusters, hardness modifiers, optical agents, and combinations thereof.

Preferably, the preferred embodiment composite materials comprise an effective amount of the nanostructures. The term “effective amount” as used herein refers to an amount of the particular nanostructure that when incorporated into the matrix material of the composite materials described herein, result in the composite materials exhibiting desired properties or characteristics. Generally, an effective amount of nanostructures is from about 0.25% to about 20% of the composite material, and more preferably from about 2% to about 10% (all percentages expressed herein are percentages by weight of the composite material unless otherwise noted). When utilizing carbon nanotubes and/or carbon nanofibers as the nanostructures, it is preferred that the effective amount of the carbon nanotubes and/or the carbon nanofibers in the composite material ranges from about 0.1% to about 25%, more preferably, from about 1% to about 15%, and more preferably from about 2% to about 10% based upon the total weight of the composite material.

The preferred embodiment composite materials of the present invention contain nanostructures having aspect ratios greater than 1.0, dispersed and aligned in a parallel orientation with respect to each other, in a matrix material. Preferably, at least a majority, i.e. at least 50%, of the nanostructures are oriented in this parallel orientation. More preferably, at least 75% of the nanostructures are oriented in this parallel orientation. Yet still more preferably, at least 90% of the nanostructures are oriented in this parallel orientation. In certain instances, it is even more preferable that at least 95% of the nanostructures are oriented in this parallel orientation. And, most preferably for certain applications, at least 99% of the nanostructures are oriented in this parallel orientation.

As noted, the present invention also relates to various preferred embodiment composite materials based upon combinations of one or more nanostructures such as carbon nanotubes and/or carbon nanofibers dispersed in a matrix of glass or metal. It is contemplated that such materials can be used in the production of high performance glass and metal nanocomposite fibers, sheets and nanocomposite flywheel rings.

Representative examples of such materials include, but are not limited to high performance composite glass/nanotube materials in the form of fibers with a minimum tensile strength of 20-25 GPa and a minimum tensile modulus of 200-250 GPa. Such materials may be used in high performance flywheel rings with oriented nanofibers and/or nanotubes in the hoop direction by hot rolling. Also contemplated are high performance nanocomposite wires, sheet metal, and bulk materials with superior thermal and electrical properties by combining various types of nanotubes and/or nanofibers with one or more metals such as for example, copper, aluminum, and titanium.

As noted, a wide array of composite material products can be formed using the present invention. For example, fibers or strands of a matrix material reinforced with dispersed and aligned nanostructures as described herein, can be incorporated in a secondary material to impart beneficial properties to the secondary material. For example, a glass fiber reinforced with nanostructures as described herein can be produced. An effective amount of that reinforced glass fiber can be incorporated in a secondary material to impart desired physical properties such as tensile strength, to the secondary material. Representative examples of such secondary materials include, but are not limited to polymeric materials, glass, metals, cellulose-based materials, and combinations or composites thereof. Another representative example is the incorporation of glass fibers reinforced with nanostructures which are then incorporated into fibrous or woven composite materials. In this technique, nanostructure-reinforced fibers are incorporated into a randomly oriented fibrous matt which can then be processed as known in the art. Alternately, the nanostructure-reinforced fibers can be incorporated into an aligned, relatively flat plane or layer, and used in a multi-layer fiber assembly. The fibers can also be used in a thin sheet of randomly oriented fibers.

It is also contemplated to incorporate the nanostructure-reinforced fibers into a matrix material and form layers of a composite material. The layers can then be stacked or otherwise joined as desired.

In certain applications it may be desired to form layers of such composite materials in which a predetermined proportion of the nanostructure-reinforced fibers are aligned with one another and/or aligned in a certain direction relative to the layer of composite material. Collections of such stacked and aligned layers can be formed as desired. This strategy enables the production of composite materials with exceedingly high strengths in particular directions.

Thus, it will be understood that the present invention includes composite materials using a primary matrix material having dispersed within it, an effective amount of the nanostructures as described herein. The composite of the nanostructures and primary material can then be combined with a secondary matrix material. The secondary matrix material may also comprise the nanostructures described herein, conventional reinforcing materials or additives, or be used by itself. The resulting composite material may feature the primary matrix material (and nanostructures) and the secondary matrix material in a variety of configurations such as intimately mixed with one another or disposed in separate distinct regions. It is also contemplated to utilize third and subsequent matrix materials.

Generally, the performance of the preferred nanocomposite materials can be estimated based on preliminary results and various published or projected properties of carbon nanotubes. Various physical properties of preferred nanomaterials used in the preferred embodiment composite materials in accordance with the present invention are compared to several known materials in Table 1, below.

TABLE 1
Comparison of Physical Properties of Carbon
Nanotubes to Known Materials

| | Young's | | |
|---|---|---|---|
| Material | modulus (GPa) | Tensile Strength (GPa) | Density (g/cm³) |
| Single wall | 1054 | 150 | |
| nanotube | | | |
| Multi wall | 1200 | 150 | 2.6 |
| nanotube | | | |
| Steel | 208 | 0.4 | 7.8 |
| Epoxy | 3.5 | 0.005 | 1.25 |
| Wood | 16 | 0.008 | 0.6 |

As explained in greater detail herein, fibers were formed from a composite material comprising carbon nanofibers dispersed in a glass matrix. Collections of these fibers were then formed into tows, i.e. untwisted bundles of continuous untwisted filaments. Tensile strength tests demonstrate that although the concentration of carbon nanofibers in the composite fibers was relatively low, e.g. from about 0.25 to about 0.5%, and non-uniform among the individual filaments (198 filaments), the strength of the hybrid fiber tows was on the average 60% higher and reached close to 100% of the theoretical value in a few of the samples. It is projected that the tensile strength of the fibers along with the thermal and electrical properties will increase significantly depending on the concentration and the type and/or blend of nanotubes/nanofibers used.

The preferred embodiment materials can be used to produce hot extruded metallic coupons or intermediate products of nanocomposite matrices. The coupons can be produced using a hot press operation. Generally, the process involves dispersing the nanostructures such as nanotubes in metal powders by mixing and milling under inert conditions. The mix is melted in a graphite jig inside a hot press chamber under inert conditions. After melting, the melt is extruded through a hole in the bottom of the jig, thereby forming essentially an exit die, under high pressure. The process can produce wires and/or flat ribbon coupons depending on the shape and the dimensions of the die at the bottom of the jig.

Composite metallic fibers comprising carbon nanofibers can be formed as follows. Two types of carbon nanofibers available from Pyrograf® Products, Inc. of Applied Sciences Inc., of Cedarville, Ohio, are processed as follows.
1. PR LH 24 CNF, processed at 1500° C. to optimize the mechanical and electrical properties.
2. PR HH 24 CNF, processed at 3000° C. to optimize the thermal properties.

The composite fibers are then formed as described herein. The concentration of the carbon nanofiber in the composite material can range from about 0.1% to about 14%. The volume of the carbon nanofibers at 14% concentration will most likely exceed that of the metal matrix. In addition, the use of other types of nanotubes in the composite matrix can be varied, such as boron nitride and silicon carbides to enhance the performance of the resulting nanocomposites.

In what is believed to be the first published results of a composite material using boron nitride nanotubes, one of the present inventors reported significant increases in strength and fracture toughness of glass composites, see N. P. Bansal and J. B. Hurst, “Boron Nitride Nanotubes-Reinforced Glass Composites,” NASA/TM-2005-213874, prepared for the 30^{th} International Conference and Exposition on Advanced Ceramics and Composites, sponsored by the American Ceramic Society, Cocoa Beach, Fla., Jan. 22-27, 2006. Although providing a significant advance in the art, this work did not address the same problems as the present invention.

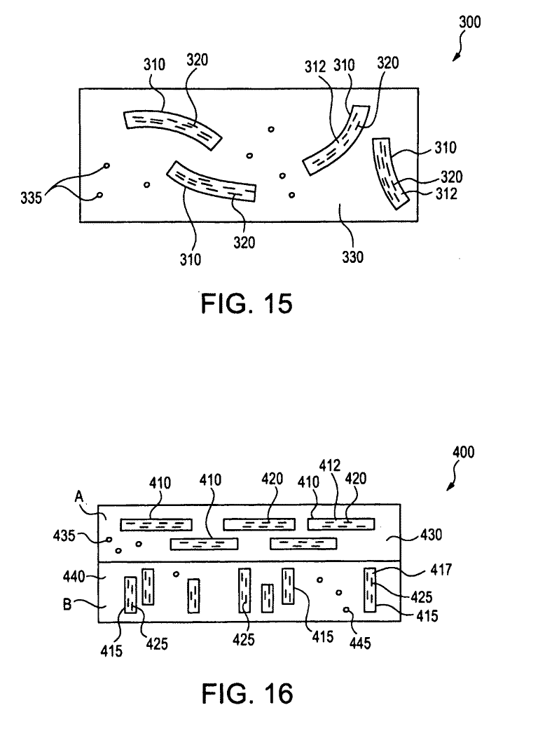

In accordance with the present invention, a wide array of composite products utilizing nanostructures can be produced. FIGS. 15-18 illustrate several representative examples of such products using oriented nanostructures in accordance with the invention. It will be appreciated that in no way is the invention limited to these representative examples. FIG. 15 is a schematic cross section of a preferred composite material 300 comprising a plurality of reinforced fibers or strands 310 that include aligned nanostructures 320 dispersed in a first matrix material 312. The fibers 310 are dispersed in a second matrix material 330 which may optionally include one or more additives or other components 335. The nanostructures 320 are generally aligned with respect to each other and preferably, generally parallel with the longitudinal axis of the respective fiber 310. The fibers 310 having the nanostructures 320 dispersed therein are preferably formed as described herein. The fibers 310 can be aligned or otherwise selectively oriented within the second matrix material 330, or can be randomly oriented as depicted in FIG. 15.

FIG. 16 is a schematic cross-sectional illustration of another preferred composite material 400 in accordance with the present invention. Material 400 comprises two or more distinct and generally separate regions such as regions A and B. Region A comprises fibers or strands 410 that include nanostructures 420 dispersed and aligned within a first matrix material 412. The fibers 410 are dispersed within a second matrix material 430 along with optional additives or components 435. A feature of region A is that the fibers 410, or at least a portion of the fibers 410, are aligned within the region A. Region B comprises fibers or strands 415 that include nanostructures 425 dispersed and aligned within a third matrix material 417. The fibers 415 are dispersed within a fourth matrix material 440 along with optional additives or components 445. In region B, all or a portion of the fibers 440 are aligned within that layer. It will be appreciated that some or all of the first, second, third, and fourth matrix materials may be the same or different. The embodiment depicted in FIG. 16 exemplifies a configuration in which the orientation of nanostructures in adjacent regions is perpendicular. The invention includes configurations in which the respective orientations of nanostructures in different regions are parallel to one another or at particular angles with respect to each other or that of the composite material 400. Although a planar configuration is depicted in FIG. 16, it will be appreciated that the present invention includes configurations such as agglomerated collections of distinct regions.

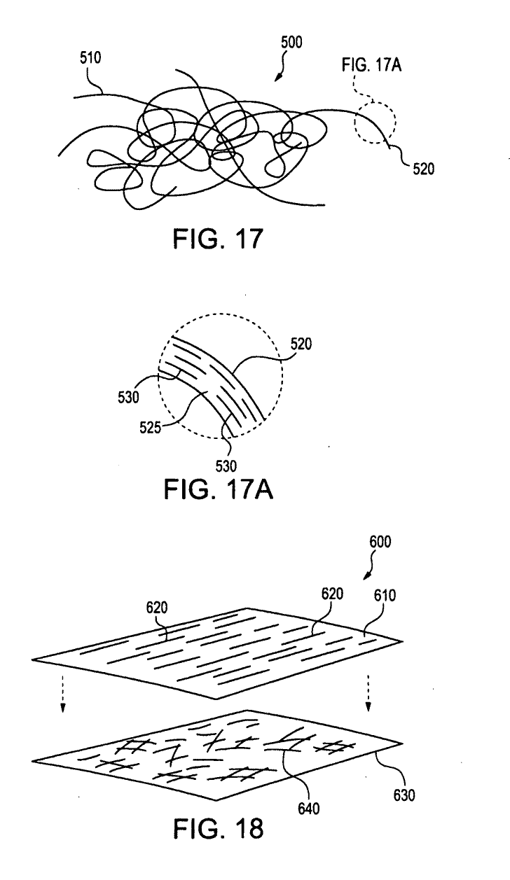

FIGS. 17 and 17A illustrate another preferred embodiment composite product 500 in accordance with the present invention. Product 500 is fibrous in nature and comprises a plurality of fibers or strands 520 comprising aligned nanostructures 530 dispersed in a matrix material 525. The product 500 may optionally comprise one or more additional fibers 510 incorporated into the product 500. Although the product 500 is depicted in FIG. 17 as comprising fibers that are randomly oriented, it is to be understood that the present invention includes composite product configurations in which the fibers, particularly those including aligned nanostructures such as fibers 520, are disposed in an ordered or aligned array such as a woven fibrous layer.

FIG. 18 illustrates another preferred composite material 600 that comprises multiple thin layers such as 610 and 630. One or more of the layers comprises fibers or other particulates that include aligned nanostructures. For example, layer 610 includes a plurality of fibers 620, each having aligned nanostructures incorporated within their interior or structure. Preferably, the fibers 620 are aligned within the layer 610. The layer 630 comprises one or more types of secondary fibers 640 which can also be of the same type as fibers 620, or different such as conventional additive fibers. The fibers 640 are randomly oriented within the layer 630, however other orientations are contemplated and included in the present invention. Each of the layers 610 and 630 preferably comprises a binding material or other matrix material to retain the fibers incorporated therein.

It is to be understood that although all of the embodiments shown in FIGS. 15-18 utilize fibers that comprise aligned nanostructures, the present invention includes other configurations such as sheet-like structures, and structures having nearly any geometrical shape, which comprise aligned nanostructures.

The present invention also relates to methods for forming the composite materials described herein. A significant feature of the preferred embodiment methods is that the final dispersing and aligning of the nanostructures in the matrix material are performed at high temperatures while the matrix material, e.g. glass or metal, is in a flowable or molten state; and while the Van der Waals forces between the nanostructures are in an extremely weakened state. If the matrix comprises one or more metals, providing the matrix in a flowable state also eliminates the presence of any grain structure in the metal. This strategy exploits the fact that when high aspect ratio nanotubes are incorporated in a slurry or otherwise flowable matrix and the mixture is forced to flow in a laminar fashion, the nanotubes will align themselves along the direction of the flow. The shear forces in a highly viscous, viscoelastic and plastic flow are enormous and easily overcome the Van der Waals forces. Accordingly, the nanotubes avoid agglomerating and otherwise creating defects. The combination of these processing steps while the materials are in a flowable or molten state, surprisingly results in an extremely strong nanocomposite (alloy) matrix with well dispersed and aligned nanotubes that are imbedded within the matrix or grain structure rather than on the surface.

More specifically, a significant feature of the preferred embodiment processes described herein is the selection of process parameters so as to induce laminar flow of the combined nanostructures and matrix material. This strategy causes at least a portion and typically a majority or all of the nanostructures to disperse and adopt a parallel orientation in the matrix material. Preferably, the parallel oriented nanostructures are also oriented substantially parallel with the direction of flow.

Laminar flow, or sometimes known as streamline flow, occurs when a fluid flows in parallel, or generally parallel layers, with little or no disruption between the layers. In fluid dynamics, laminar flow is a flow regime characterized by high momentum diffusion, low momentum convection, and pressure and velocity independent from time. Generally, laminar flow is opposite from turbulent flow. As will be appreciated by those skilled in the art, laminar flow is generally denoted by a dimensionless parameter known as the Reynolds Number. Specifically, a flowing system is generally considered to be undergoing laminar flow when the Reynolds Number is less than about 2300. Generally, the Reynolds Number (Re) is the ratio of dynamic pressure (p*u²) and shearing stress (μ*u/L):

$$R e = \frac{( p * {u}^{2} )}{μ * u / L}$$

where Re=Reynolds Number (dimensionless)
p=fluid density,
u=mean fluid velocity
p=absolute dynamic fluid viscosity, and
L=characteristic length.
   Generally, a flowing system is considered to be turbulent if the Reynolds Number is greater than about 4000. In the region of about 2300 to about 4000, the flow is considered transient.

In accordance with the present invention, the flowable matrix material and the nanostructures incorporated therein, are caused to flow in a laminar fashion for a period of time sufficient for at least a majority of the nanostructures to adopt a parallel orientation in the matrix material. The amount of time will vary depending upon flow characteristics, system parameters and properties of the matrix material and the nanostructures. Although not wishing to be bound to any particular time range, it is contemplated that such periods of time may be on the order of a second or less, and in other applications, may be as long as several minutes.

In the preferred processes of the invention, the matrix material, is transformed into a flowable state. Preferably, this is accomplished by heating. For glass or fused silica materials, the minimum temperature to which the material is heated generally corresponds to the melting or liquidus temperature of the glass or silica material. For most glasses and/or silicas, this temperature is from about 1000° C. to about 1600° C., and more preferably from about 1000° C. to about 1200° C. For metals as the matrix material, the minimum temperature generally corresponds to the melting temperature of the metal. For most metals, this temperature is from about 600° C. to about 2000° C., and more preferably from about 800° C. to about 1600° C.

After the nanostructures have been appropriately dispersed and aligned within the hot matrix material, and preferably after at least a majority of the nanostructures have adopted a parallel orientation in the matrix material as a result of establishing laminar flow of the system, the matrix material can be solidified to preserve the orientation of the nanostructures. Solidification can be performed by cooling of the matrix material. Contact with water or other liquid having a high heat capacity is preferred.

Carbon in its many forms, including carbon nanotubes, degrades when exposed to temperatures exceeding 400° C. in the atmosphere or in an oxygen-rich environment. This consequence led many researchers to conclude that it is not feasible to imbed carbon nanotubes in hot matrices such as glass melts which are typically processed at temperatures close to 1000° C. (1200° C. for E glass). With this in mind, it is not surprising that the literature is essentially devoid of any efforts of incorporating the carbon nanotubes/carbon nanofibers in matrices that are processed at temperatures above 400° C.

In spite of conventional views concerning this matter, investigations were conducted by incorporating or imbedding nanotubes in high temperature, i.e. 1000° C. to 1600° C., matrices such as glass. It was surprisingly discovered that such strategies were successful at protecting the carbon nanotubes in hot matrices. As explained in greater detail herein, it has been demonstrated that, not only do carbon nanofibers (CNF) survive the relatively high processing temperature, e.g. typically about 1200° C., but they are also readily dispersible and align themselves within the glass or metal matrix upon laminar flow being established. Furthermore, it has been surprisingly demonstrated that mixing glass frit and nanotubes under inert conditions and later hot pressing the mixture did not cause any measurable damage to the nanotubes. Therefore, it is contemplated that the components of the composite material, e.g. the nanomaterials, and the matrix material(s), can be mixed prior to or during the heating operation. Moreover, it has been demonstrated that the nanotubes survived hot pressing at temperatures close to 1600° C. for over an hour. The 1600° C. temperature is the maximum temperature that was used in the investigations rather than the upper limit of the working temperature for the nanotubes. The upper limit remains to be determined.

These findings were later confirmed in additional investigations conducted using a glass fiber drawing facility. Samples described in greater detail herein, were dropped directly into a glass melt which was at a temperature of 1200° C. The results indicate that the carbon nanofibers survived the hot glass fiber drawing process which was confirmed by electron microscope images and optical fluorescence induced by long wave UV light.

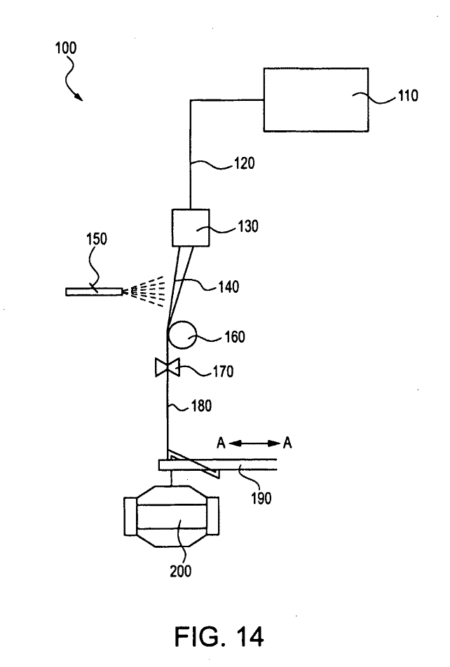

FIG. 14 is a process schematic of a preferred embodiment glass fiber drawing system 100. The system 100 comprises a source 110 of the composite material, preferably in a flowable or sufficiently heated state. The flowable material is transferred through flow line 120 to a bushing or die assembly 130. As explained herein, the flow is laminar such that the nanostructures in the matrix material are dispersed and aligned. The bushing preferably includes a collection of dies or passages through which the flowable material is passed, which form the material, i.e. “draw”, the material into relatively thin fibers or strands. The resulting collection of fibers 140 are then cooled to solidify the material, preferably by the use of sprayer 150 which typically administers water at a temperature less than that of the material. Heat transfer occurs to cool and thus solidify the matrix material. The collection of fibers are then passed to a sizing applicator 160 which coats the fibers with anti-sticking agents and/or special coatings to enable better bonding to the matrix material(s). The use of a sizing applicator and implementation of such an operation is optional. A gathering shoe 170 can be utilized to assist in bundling or forming groups of fibers 180. The collection of fibers 180 is then directed to a traverse unit 190 which imparts a reciprocating transverse motion in the direction of arrows AA to the fibers 180 prior to their winding about a spool or other container by winder 200.

In certain applications, it may be preferred to perform the preferred embodiment processes or a portion of the processes in an inert atmosphere. The term “inert atmosphere” as used herein refers to an environment of non-reactive gases, and specifically an atmosphere essentially free of oxygen. Examples of inert atmospheres are those comprising the noble gases such as argon, krypton, xenon, and radon; and/or elemental inert gases such as helium and neon. Additional examples of inert atmospheres include those comprising generally non-reactive gases such as carbon dioxide and/or nitrogen. Preferably, the inert atmosphere comprises one or more of nitrogen, argon, and carbon dioxide. However, it will be appreciated that in many applications, it will not be necessary to employ an inert atmosphere because once the nanostructures are incorporated into the matrix material, they are essentially shielded from the atmosphere by the matrix material.

The benefits of the present invention and various preferred embodiments described herein are particularly useful when working with carbon nanotubes or carbon nanofibers. These nanostructure materials are frequently adhered or “clumped” together, and in many instances, are tangled or intertwined with one another. The tendency for the carbon nanostructures to adhere together stems from the Van der Waals forces between adjacent structures. Merely combining the clumped and/or intertwined carbon nanostructures to a matrix material typically does not cause the nanostructures to depart from their clumped and/or intertwined form. However, in accordance with the present invention, after combining the nanostructures with the matrix material, causing the resulting collection to flow results in dispersion and separation of the nanostructures from one another. As previously explained herein, the shearing forces encountered by the nanostructures during flow readily overcomes the relatively weak Van der Waal's forces serving to retain the nanostructures together or intertwine them.

Success of the preferred embodiment methods is believed to result from certain operations which are used to disperse and to orient the nanotubes and/or nanofibers in the matrix of the composite material while the matrix is in a flowable state. In addition, the method used for feedstock preparation and the particular processing conditions are additional key aspects to the survivability of the nanotubes at high temperature and to dispersing the nanotubes and/or the nanofibers in the matrix.

The following is a summary of the aforementioned key aspects of the preferred embodiment methods for forming the composite materials described herein. It will be understood that although the following description is primarily with regard to nanotubes and/or nanofibers, the present invention includes any nanostructure having an aspect ratio greater than 1.0. Nor is the invention limited to the use of carbon nanomaterials. Instead, any material which can be formed into an appropriately sized and shaped nanostructure may be suitable.

### Alignment and Dispersina of the Nanotubes and Nanofibers

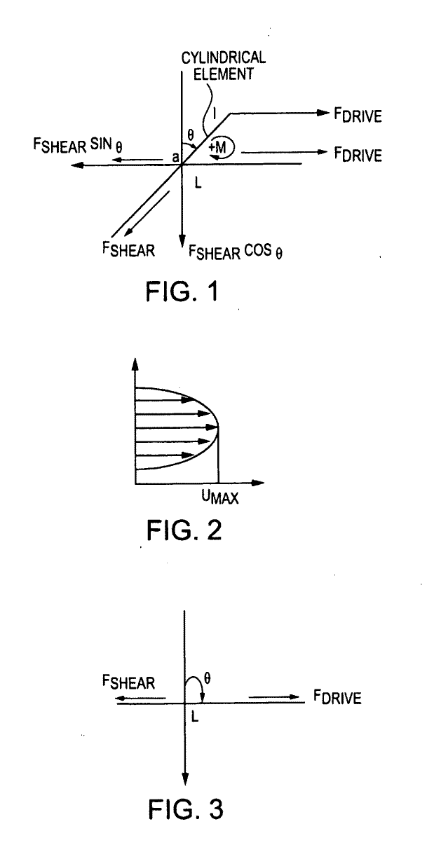

Aligning the high aspect ratio nanotubes and nanofibers in a flow is achieved by (i) the flow being laminar and (ii) velocity differentials existing across the flow profile in order to develop velocity differentials at different locations on the nanotube and/or nanofiber, and thus forming turning moments along the length of the nanotube and/or nanofiber. The turning moments on the nanotubes or nanofibers causes them to rotate into a configuration which reduces the moments to zero. And so, the fibers will become aligned in the direction of the flow as illustrated in the diagram of FIGS. 1-3. Specifically, FIG. 1 illustrates a force diagram with a turning moment M resulting from application of shear forces and drive forces imparted upon a nanotube or nanofiber by a matrix material flowing in a laminar fashion. FIG. 2 is a velocity profile of a flowing material when such flow is laminar. Typically, the velocity profile of such flow is parabolic in shape. That is, velocity vectors corresponding to velocities at different locations across a flow cross-section, generally trace a curve that is parabolic in shape. As will be understood, flow streams within the interior or mid-region of a flow channel or profile will typically exhibit a greater velocity than flow streams along the edges or end regions of the channel or profile. FIG. 3 illustrates attainment of a zero turning moment by a nanotube or nanofiber once the nanotube or nanofiber is aligned within the flow. In view of this phenomenon, the preferred embodiment materials and processes utilize nanostructures that have aspect ratios greater than 1.0, thereby facilitating their alignment in the direction of flow.

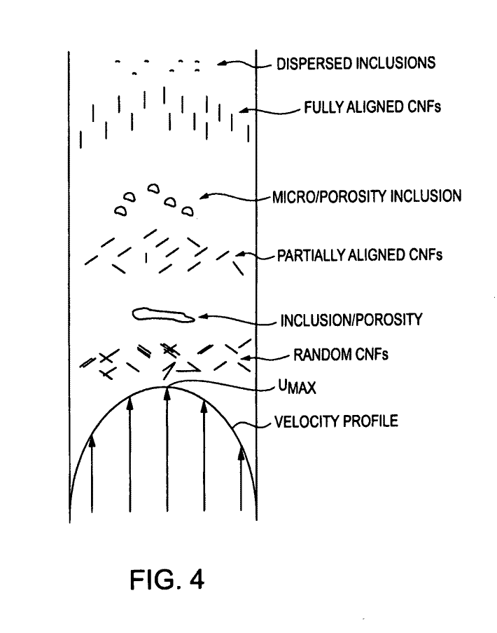

FIG. 4 is a schematic illustration showing progression of (i) reduction of inclusions or porosity voids, and (ii) dispersing and alignment of carbon nanofibers dispersed in a laminar flowing matrix material. During early phases of the flowing system, such as depicted in the lower region of FIG. 4, the random orientation of the carbon nanofibers is apparent. As the flowing system continues, the carbon nanofibers begin to partially align as shown. After a relatively short period of time, the carbon nanofibers become fully aligned. Similarly, the relative size of any inclusions or porosity voids also tends to become smaller, as shown in FIG. 4. This is another surprising benefit associated with the present invention. Although not wishing to be bound to any particular theory, it is believed that inducing and maintaining a laminar flow, particularly as compared to a turbulent flow, promotes the elimination or at least reduction in the number and severity of inclusions and voids in the system.

As noted, inducing laminar flow of the combined matrix material and nanostructures dispersed therein, causes dispersing and alignment of the nanostructures within the matrix material. However, in certain applications, it may be desired to perform a secondary operation to further promote alignment of the nanostructures. In the case of viscoelastic and plastic flow, there is considerable microscopic shearing and slippage between the flow planes due to the differentials in the velocity profile of the flowing material as is the case during fiber glass forming, wire drawing operations and rolling operations, e.g., sheet metal rolling. This was demonstrated in testing results described herein for the case of glass composite material fibers. Generally, 0.125 inch diameter tips were used to drip a slurry of molten flowable glass matrix material comprising nanotubes and nanofibers dispersed therein, which was quickly pulled or drawn to a diameter of 7-10 μm over a distance of less than one inch. This created very large velocity differentials and considerable shear in the flow and as such, readily further dispersed and aligned the nanotubes/nanofibers in the glass fibers.

### Secondary Operations for Improved Dispersing

Once a fiber is drawn, porosity voids, inclusions or agglomerations may exist within the fiber. However, these will not be larger than the diameter of the fiber, otherwise this would cause the fiber to break or otherwise sever. Therefore, in the case of a fiber that is 7-10 μm in diameter, the largest inclusion and/or agglomeration must be smaller than the corresponding fiber diameter. The length of the inclusions, however, is not limited and could in theory, be extremely long. In accordance with the present invention, this problem can be remedied by chopping the fibers into discrete units having appropriate lengths, remixing them, heating the resulting collection to form a flowable material, and redrawing the material into fibers or casting the blend into bars or ingots for later processing into final products. An appropriate length for the chopped fibers is preferably a length that is greater than the length of the nanostructures incorporated into material. For example, if fibers are formed comprising nanotubes which are 200 to 300 microns in length, chopping the fibers into lengths shorter than this range would be undesirable. Otherwise, the nanotubes themselves would be severed. This process is particularly preferred for glass, fused silicas and metal powders.

Certain processing applications or production operations involve a feed material that is merely deformed, e.g. via plastic deformation, instead of undergoing a laminar flow. Examples of such applications are cold rolling or wire drawing of a metal bar to form a thin sheet or wire, as desired. One wishing to incorporate and align nanostructures in the product of such an operation may encounter difficulty in achieving sufficient dispersion and alignment of the nanostructures within the metal matrix. To overcome this difficulty, the feed material, e.g. metal in the present example, is heated to a flowable or molten state, and then mixed or otherwise combined with the nanostructures. The resulting blend is then flowed, preferably a laminar flow, to disperse and align the nanostructures within the metal matrix. The resulting composite feed material is then cooled to retain the aligned orientation of the nanostructures. The resulting composite material is then used as feed for the deforming operation such as cold rolling or wire drawing. In this fashion, products of a wire drawing operation can readily be provided that comprise effective amounts of aligned nanostructures. Similarly, products of a cold rolling operation such as thin metal sheets or foils can be produced that contain effective amounts of aligned nanostructures.

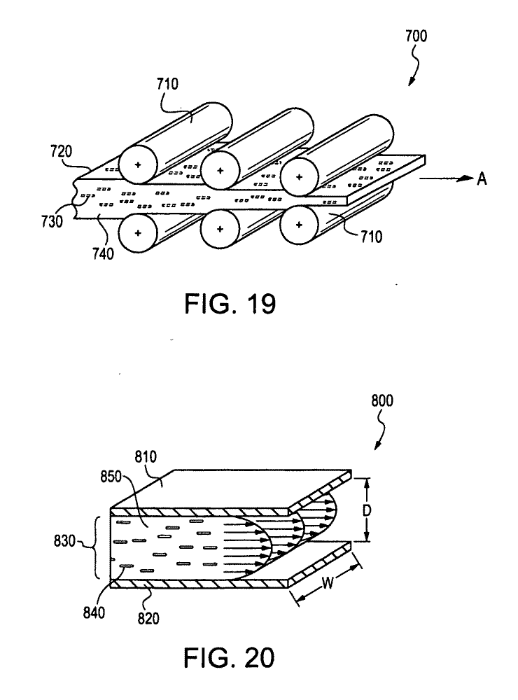

FIG. 19 schematically illustrates a roller and wire drawing process for producing wires or sheets of material comprising aligned nanotubes as described herein. An assembly 700 comprising a plurality of rollers 710 receives a feed material 720 that includes a collection of oriented and aligned nanostructures 730 dispersed in a matrix material 740. As the feed material 720 progresses past the opposing pairs of rollers 710 in the direction of arrow A, the material 720 is deformed into a desired shape or dimension.

FIG. 20 is a schematic depiction of orientation and alignment of nanostructures occurring as a result of laminar flow between two parallel, or substantially parallel, plates or walls. Assembly 800 comprises a first plate 810 and a second plate spaced from the first plate and generally parallel thereto. A flowable material 830 comprising nanostructures 840 dispersed in a matrix material 850 is caused to flow in a laminar fashion (note the parabolic shape of the velocity profile), between the plates or walls 810 and 820. It will be appreciated that the width W and depth D of the flow channel can be tailored as desired by the artisan or as dictated by the application. For example, a wide sheet of relatively large dimensions having nanostructures dispersed throughout its thickness and aligned to be generally parallel with the plane of the sheet and further aligned along an axis of the sheet, can be formed by flowing such material through a channel as shown in FIG. 20, in which the ratio of W to D is relatively large.

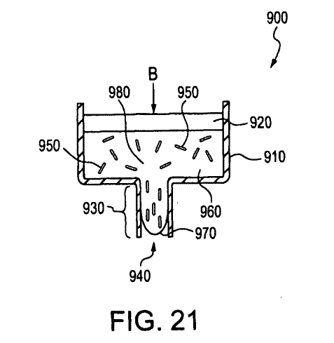

FIG. 21 is a schematic depiction of an assembly 900 for extruding material through a die. Specifically, in the assembly 900, material 980 comprising nanostructures 950 in a matrix material 960 is introduced into a container or receiving unit 910. The receiving unit 910 includes a displaceable piston 920 and an exit port 940. Preferably, the unit 910 defines a narrowed region or channel 930 upstream of the exit port 940. It will be appreciated that an extrusion die may be used at the exit port 940. Upon movement or translation of the piston 920 in the direction of arrow B, the material 980 is caused to flow through the channel 930 and out of the exit port 940. As explained herein, it is preferred that the conditions of flow within the channel 930 are selected such that the flow in that region is laminar. Preferably, a parabolic velocity profile for that flow is established such as designated by 970.

### Feedstock Preparation

Mixing nanotubes and/or nanofibers with dry glass frit and milling the mixture for an extended period of time under inert conditions using nitrogen or argon gas serves to disperse the nanotubes and/or nanofibers in the mix and protect them from oxidation by shrouding them with the inert atmosphere. Removing oxygen from the immediate surroundings of the carbon nanotubes/nanofibers is critical to preventing their deterioration while processing at high temperatures.

### Glass Fiber Drawing Process

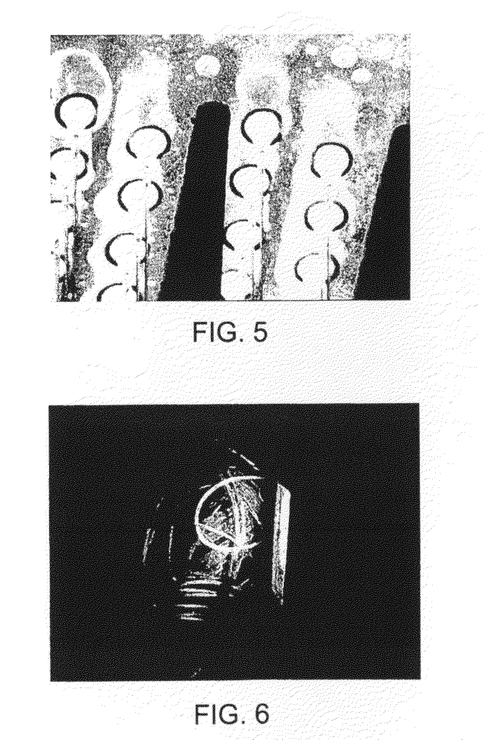

As noted, in certain instances or applications, it may be preferred to utilize a glass drawing operation to further promote alignment of the nanostructures within the matrix material. A preferred glass drawing facility produces continuous lengths of glass fibers, preferably 7-10 μm in diameter. The glass is heated to its melting temperature. For E glass, the melt temperature is about 1200° C. The input material in this process is solid E glass marbles (or frit) of different formulations depending upon the end use application. The molten glass is gravity fed into a plurality of dies such as a platinum bushing with 200 tips, each 1.8 mm in diameter as shown in FIG. 5. Individual fibers are pulled from each tip and the diameter of the glass is attenuated from the 1.8 mm starting point to the final mean diameter of the fibers, which can be for example, 7-10 μm.

### Testing Results

Preliminary results indicate that the proposed methodology for reinforcing a matrix material such as glass microfibers, with a nanostructure material such as carbon nanotubes/carbon nanofibers, is indeed viable.

The investigations conducted were not controlled in that the ultimate and exact concentration of the carbon nanofibers in the glass filaments was not known. However, the concentration was estimated, and this study indicates the significant advantages provided by the present invention. A 20 gram E glass/carbon nanofiber coupon containing 40% carbon nanofibers was dropped in the center of the melter of a glass drawing tower which contained 40 pounds of undisturbed E glass. Due to the difference in the specific gravities of the coupon and the pure E glass and also due to the lack of agitation, the carbon nanofibers did not mix uniformly with the undisturbed glass in the melter.

The resulting molten material comprising E glass as the matrix material and carbon nanotubes and carbon nanofibers as the high aspect ratio nanostructures dispersed therein, flowed in a laminar fashion to a glass fiber bushing tip assembly, as previously described and shown in FIG. 5. The flowing mass was further subjected to a pulling or drawing operation to thereby form the fibers of the glass composite material.

The drawn filaments were continuous and their diameter was on the order of 30-40 μm. The filament's diameters were larger than the normal diameter because the fibers were not pulled and wound to a smaller diameter. It is estimated that in a best case scenario, the concentration of the carbon nanofibers in the glass filaments was fairly low, perhaps on the order of about 0.25% to about 0.5%. This was ascertained from the fact that the filaments did not exhibit a change in color to the naked eye. However, the areas of the filaments containing the carbon nanofibers fluoresced in the gold color region when exposed to UV long wave light (354 nm) as is shown in FIG. 6. That figure also validates the expected non-uniform distribution of the carbon nanofibers between the individual filaments due to the poor mixing process.

Optical tests conducted on the bulk carbon nanotube material demonstrated a lack of fluorescence in the visible spectrum (the infrared band was not explored). This behavior, i.e., the lack of fluorescence in the bulk and strong fluorescence when dispersed in the glass filaments, is consistent with the behavior of bulk and nano silicon which has strong fluorescence in the dispersed nano-state and none in the bulk state.

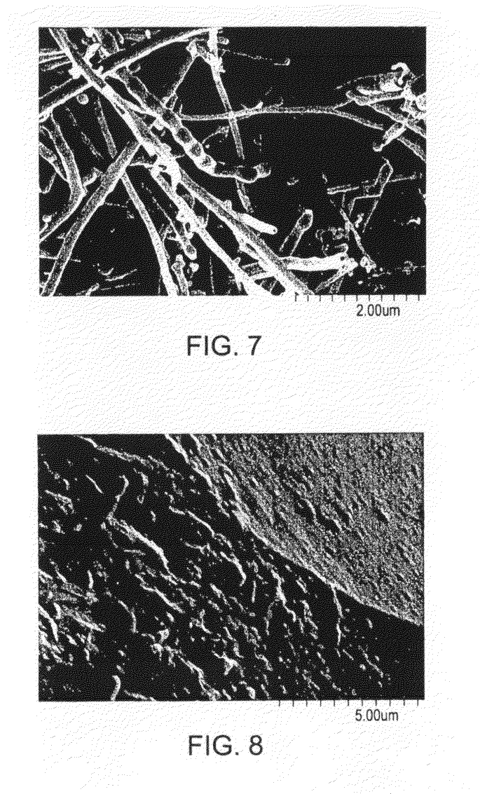

The carbon nanofibers used in the investigations were multi-wall carbon nanofibers shown in FIG. 7. FIG. 7 is a scanning electron microscope (SEM) micrograph of the multi-wall carbon nanofibers taken at 3.0 KV, 13.2 mm×20.0 K. The multi-wall carbon nanofibers used were obtained from Pyrograf® Products, Inc., a subsidiary of Applied Sciences, Inc. of Cedarville, Ohio. Table 2 lists their nominal properties after heat treating:

TABLE 2

| Characteristic or Property | Value |
|---|---|
| Mean diameter: | 100-200 nm |
| Mean length | 200-300 μm |
| Tensile strength | Approximately 7-15 GPa |
| Tensile Modulus | 600 GPa |
| Density | 2.1 g/cm³ |
| Optical Properties | Black none fluorescent in bulk |
| Electrical Resistively | 55 Microohm/cm |
| Thermal Conductivity | 1950 W/m-K |

Preliminary analysis of the hybrid fibers indicate that the carbon nanofibers were well dispersed and aligned along the axis of the E glass filaments as is shown in FIG. 8. FIG. 8 is an SEM micrograph taken at 3.0 KV, 13.4 mm×9.00 K.

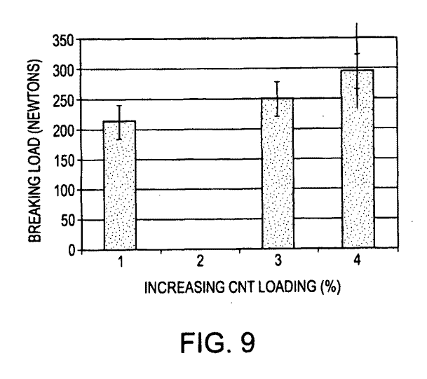

Pull tests were conducted on a population of 20 tows of glass composite fibers each containing approximately 200 filaments. The tests indicated that there is a significant increase in the tensile strength of the fibers containing the carbon nanofibers. As evident from FIG. 9, breaking load of the composite fiber increased as the concentration of the carbon nanotubes increased. The results of the pull tests are displayed in FIG. 9, and indicate that the strength of the fibers increased by nearly 60% and in some cases doubled.

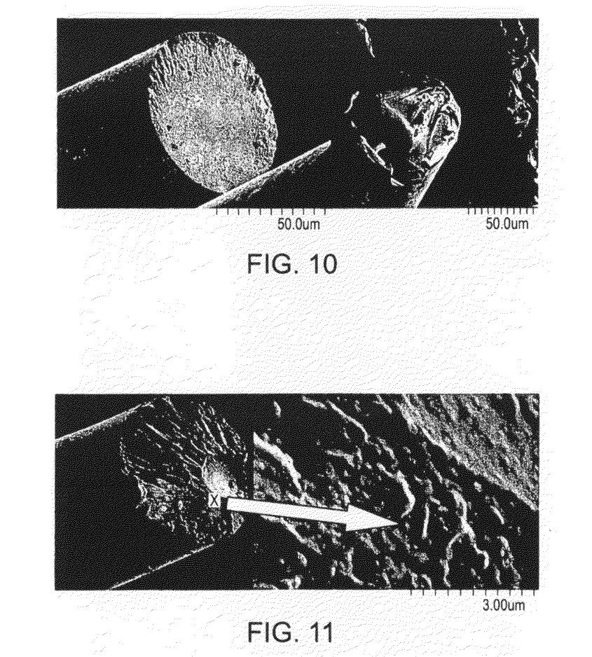

The fracture surfaces of the hybrid fibers were considerably different from that exhibited by normal E glass fibers. FIG. 10 shows that the brittle fracture surface shown on the left in the image is considerably modified due to the presence of the carbon nanofibers in the fibers on the right. FIG. 10 is an SEM micrograph (left) taken at 3.0 KV, 14.7 mm×1.00 K; and an SEM micrograph (right) taken at 3.0 KV, 6.8 mm×6.00 K.

Close inspection of the break surfaces showed that the carbon nanofibers were indeed well dispersed and aligned along the length of the axis of the fibers as shown in FIG. 11. FIG. 11 is an SEM micrograph (left) taken at 3.0 KV, 13.4 mm×8.00 K; and an SEM micrograph (right) taken at 3.0 KV, 13.4 mm×18.0 K.

### Additional Embodiments

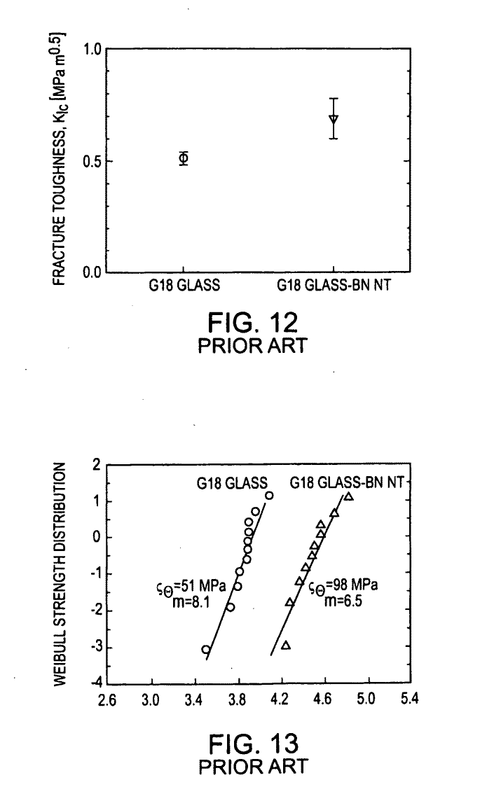

As noted in the reported previous work by one of the present inventors, concerning composite materials using boron nitride nanotubes, it has been demonstrated that significant improvement in the strength of glass fuel cell seal materials can be obtained by incorporating 4% of boron nitride nanotubes in the glass matrix. Results indicate that the strength nearly doubled and there was a 40% improvement in the fracture toughness of the matrix by the addition of nanotubes as indicated in FIGS. 12 and 13. The length of the boron nitride nanotube in those studies is on the order of 200-300 μm. Specifically, FIG. 12 is a graph of fracture toughness of a commercially available glass G18 used in those studies and that G18 glass reinforced with boron nitride nanotubes (BN NT). Fracture toughness is expressed as K_{ic}[MPa m^{0.5}]. FIG. 13 is a detailed view illustrating Weibull strength distribution of those materials. Weibull strength distribution is Inin[1/(1−F)]. M is the Weibull modulus and ç₈ is the characteristic length. These results indicate the significant physical properties which are attainable of composite glass, ceramic, and/or metal materials using boron nitride nanostructures in accordance with the present invention.

All referenced patents, patent applications, and documents referenced herein are incorporated herein in their entirety.

The present invention has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A process for producing a high strength composite material comprising (i) an effective amount of at least one type of nanostructure having an aspect ratio greater than 1.0, and (ii) a matrix material, the process comprising:
providing a matrix material;
heating the matrix material such that the matrix material is flowable;
providing at least one type of nanostructure having an aspect ratio greater than 1.0;
combining an effective amount of the at least one type of nanostructure with the matrix material;
flowing in a parabolic laminar fashion, the combined amount of nanostructures with the matrix material, to thereby cause at least a majority of the nanostructures to adopt a parallel orientation in the matrix material;
solidifying the composite material while the nanostructures are in the parallel orientation in the matrix material to thereby produce the high strength composite material.

2. The process of claim 1 wherein the flowing operation causes at least a majority of the parallel oriented nanostructures to also be oriented substantially parallel with the direction of flow.

3. The process of claim 1 further comprising:
after flowing in a laminar fashion, subjecting the combined amount of nanostructure with the matrix material to a drawing operation to further induce parallel orientation of the nanostructures within the matrix material and form a fiber of the composite material.

4. The process of claim 1 wherein the nanostructure is selected from the group consisting of (i) single wall nanotubes, (ii) multi-wall nanotubes, (iii) nanofibers, and (iv) combinations thereof.

5. The process of claim 1 wherein the matrix material is selected from the group consisting of (i) glass, (ii) fused silica, (iii) metals, and (iv) combinations thereof.

6. The process of claim 1 wherein the matrix material is one of glass and fused silica and the heating operation heats the matrix material to a temperature of from about 1000° C. to about 1600° C.

7. The process of claim 6 wherein the matrix material is metal and the heating operation heats the matrix material to a temperature of from about 600° C. to about 2000° C.

8. The process of claim 1 wherein at least a portion of the process, prior to solidifying the composite material, is performed in an inert atmosphere.

9. The process of claim 8 wherein the atmosphere comprises at least one inert gas selected from the group consisting of (i) nitrogen, (ii) argon, and (iii) carbon dioxide.

10. The process of claim 1 wherein the fiber of the composite material is severed into a collection of discrete units having a length greater than the length of the nanostructures combined therein.

11. The process of claim 10 wherein the severed units are remixed and reheated to a flowable state, and subjected to a drawing operation.

12. The process of claim 3 wherein the fiber of the composite material is severed into a collection of fibrous components having a length greater than the length of the nanostructures combined therein.

13. The process of claim 12 wherein the severed fibrous components are remixed and reheated to a flowable state, and subjected to a drawing operation.

14. The process of claim 1 wherein the combining operation is performed when the matrix material is in a solid state.

15. The process of claim 14 wherein the solid matrix material is glass frit.

16. The process of claim 14 wherein the solid matrix material is a metal powder.

17. The process of claim 14 wherein the solid matrix material is fused silica powder.

18. The process of claim 1 wherein the combining operation is performed when the matrix material is in a flowable state.

19. The high strength composite material produced by the process of claim 1.

20. The fiber of the composite material produced by the process of claim 3.

21. A process for dispersing and aligning nanostructures in a matrix material, the process comprising:
selecting nanostructures having an aspect ratio greater than 1.0;
providing a flowable matrix material;
combining the selected nanostructures in the flowable matrix material;
flowing, in a parabolic laminar fashion, the combined matrix material and selected nanostructures for a period of time sufficient to cause at least a majority of the nanostructures to adopt a parallel orientation in the matrix material.

22. The process of claim 1 wherein the flowing operation causes at least a majority of the parallel oriented nanostructures to also be oriented substantially parallel with the direction of flow.

23. The process of claim 21 further comprising:
subjecting the combined matrix material and selected nanostructures to a drawing operation to further induce parallel orientation of the nanostructures within the matrix material and form a fiber.

24. The process of claim 21 wherein the nanostructure is selected from the group consisting of (i) single wall nanotubes, (ii) multi-wall nanotubes, (iii) nanofibers, and (iv) combinations thereof.

25. The process of claim 21 wherein the matrix material is selected from the group consisting of (i) glass, (ii) fused silicas, (iii) metals, and (iv) combinations thereof.

26. The process of claim 21 further comprising:
after at least a majority of the nanostructures have adopted a parallel orientation in the matrix material, solidifying the matrix material to preserve the adopted orientation of the nanostructures.

27. A composite material comprising:
a matrix material; and
an effective amount of at least one type of nanostructure having an aspect ratio greater than 1.0, wherein at least a majority of the nanostructures having an aspect ratio greater than 1.0 are aligned, using a parabolic laminar flow technique, in a parallel orientation with respect to each other.

28. The composite material of claim 27 wherein at least 75% of the nanostructures are aligned in the parallel orientation.

29. The composite material of claim 27 wherein at least 90% of the nanostructures are aligned in the parallel orientation.

30. The composite material of claim 27 wherein at least 95% of the nanostructures are aligned in the parallel orientation.

31. The material of claim 27 wherein at least 99% of the nanostructures are aligned in the parallel orientation.

32. The composite material of claim 27 wherein the matrix material is selected from the group consisting of glass, fused silicas, metals, and combinations thereof.

33. The composite material of claim 27 wherein the nanostructure is selected from the group consisting of (i) single wall nanotubes, (ii) multi-wall nanotubes, (iii) nanofibers, and (iv) combinations thereof.

34. The composite of claim 27 wherein the matrix material is selected from the group consisting of (i) glass, (ii) fused silicas, (iii) metals, and (iv) combinations thereof.

35. The composite material of claim 27 wherein the effective amount of nanostructure is from about 0.25% to about 20%.

36. The composite material of claim 27 wherein the effective amount of nanostructure is from about 2% to about 10%.

37. The composite material of claim 27 wherein the nanostructure is carbon nanotubes and carbon nanofibers, the effective amount of the carbon nanotubes and carbon nanofibers is from about 0.1% to about 25%.

38. The composite material of claim 27 wherein the nanostructure is carbon nanotubes and carbon nanofibers, and the effective amount of the carbon nanotubes and carbon nanofibers is from about 1% to about 15%.

39. The material of claim 27 wherein the nanostructure is carbon nanotubes and carbon nanofibers, and the effective amount of the carbon nanotubes and carbon nanofibers is from about 2% to about 10%.

40. A composite material comprising:
a reinforcing composite material including (i) a first matrix material, and (ii) an effective amount of at least one type of nanostructure dispersed in the first matrix material and having an aspect ratio greater than 1.0, wherein at least a majority of the nanostructures are aligned in the first matrix material in a parallel orientation with respect to each other using parabolic laminar flow; and
a secondary matrix material.

41. The composite material of claim 40 wherein the reinforcing composite material is dispersed within the secondary matrix material.

42. The composite material of claim 40 wherein the reinforcing composite material is in the form of fibers or strands.

43. The composite material of claim 40 wherein the secondary matrix material is in the form of fibers or strands.

44. The composite material of claim 42 wherein the secondary matrix material is in the form of fibers or strands.

45. The composite material of claim 44 wherein the reinforcing composite material and secondary matrix material are intimately mixed with one another.

46. The composite material of claim 44 wherein the reinforcing composite material and secondary matrix material are disposed in separate distinct regions of the composite material.

47. The composite material of claim 40 wherein the primary matrix material is selected from the group consisting of glass, fused silicas, metals, and combinations thereof.

48. The composite material of claim 47 wherein the secondary matrix material is selected from polymeric materials, glass, metals, cellulose-based materials, and combinations thereof.
